(19) United States
(12) Patent Application Publication
(10) Pub. No.: US 2009/0019062 A1
(43) Pub. Date: Jan. 15, 2009

(54) System and method for providing universal profiles for networked clusters

(75) Inventor: Nelson Saba, Orlando, FL (US)

Correspondence Address: CARR & FERRELL LLP, 2200 GENG ROAD, PALO ALTO, CA, 94303, US

(73) Assignee: Blaksley Ventures 108, LLC

(21) Appl. No.: 12/217,954

(22) Filed: Jul. 9, 2008

Related U.S. Application Data
(63) Continuation-in-part of application No. 12/012,796, filed on Feb. 5, 2008.
(60) Provisional application No. 60/959,019, filed on Jul. 9, 2007.

(51) Int. Cl. G06F 17/30

(52) U.S. Cl. 707/10; 707/E17.005

(57) ABSTRACT

Exemplary systems and methods for providing universal profiles for networked clusters are provided. In exemplary embodiments, membership in a first cluster is established for a member. A profile for the member is then generated that comprises profile segments associated with the first cluster. Membership in a second or subsequent cluster may also be established for the member. After which, a profile extension is provided that indicates additional profile segments associated with the second or subsequent cluster. Based on the profile extension, the profile is appended.

### CROSS-REFERENCE TO RELATED APPLICATIONS

The present application claims priority benefit of U.S. Provisional Patent Application No. 60/959,019, filed Jul. 9, 2007 and entitled “System and Method for Clustering of Group-Centric Networks,” which is incorporated by reference. The present application is also a continuation-in-part of U.S. patent application Ser. No. 12/012,796, filed Feb. 4, 2008 and entitled “Roles and Relationship Based Security in a Group-Centric Network,” which, in turn, claims the benefit of U.S. Provisional Patent Application No. 60/899,092 filed Feb. 2, 2007 and entitled “Group-Centric Social Networking,” both of which are incorporated by reference.

The present application is related to U.S. patent application Ser. No. 11/728,218 entitled “Creation of Organizational Hierarchies in a Group-Centric Network via Handshake Mechanisms,” filed Mar. 23, 2007, and U.S. patent application Ser. No. 12/012,797 entitled “Criteria-Based Creation of Organizational Hierarchies in a Group-Centric Network” filed on Feb. 4, 2008, both of which claim the benefit of U.S. Provisional Patent Application No. 60/899,092, and both hereby incorporated by reference. The present application is also related to co-pending U.S. patent applications entitled “System and Method for Clustering of Group-Centric Networks,” and “System and Method for Managing a Plurality of Network Clusters,” filed on Jul. 9, 2008, all of which are herein incorporated by reference.

### BACKGROUND

1. Field of the Invention

The present invention is generally related to networking. More particularly, the present invention is related to universal profiles in networked clusters.

2. Related Art

Presently, users may utilize social networks to communicate with others socially. These social networks are typically a collection of individuals accessing a single social network host, and typically represent both a collection of ties between people and strength of those ties. In some embodiments, the social network is a map of relationships between individuals, which indicate ways in which individuals are connected through various social familiarities ranging from casual acquaintance to close familial bonds, for example.

Typically, each individual within the social network has their own profile. Commonly, the individual also has a webpage on which any information contained in the profile may be displayed. Some information on the webpage may be private, such that only those with relationships with the individual can view the private information. Other information may be public, such that any member of the social network may be able to view the public information. However, the social networks generally require users to have a unique profile for different social networks. This may create artificial barriers between various social networks, making it difficult for users in one social network to interact with users of another social network. Additionally, unique profiles for different social networks may make it more difficult to attract new users to other social networks.

### SUMMARY OF THE INVENTION

Exemplary systems and methods for providing universal profiles for networked clusters are provided. In exemplary embodiments, membership in a first cluster is established for a member. Profile segments defined for the first cluster are then made available to the member. The member may choose to incorporate one or more of these profile segments to generate a profile.

Subsequently, membership in a second cluster may also be established for the member. When the member extends his membership, access to a profile extension is provided. The profile extension comprises additional profile segments defined for the second cluster. Based on selected profile segments associated with the profile extension, the profile may be appended. The member may extend his membership to as many clusters as desired, and associated profile extensions may be provided.

In a similar manner, a catalog of web parts used to generate a web page may be extended with each member extension. Each network cluster or groups within the network cluster define a different collection of web parts. When membership is extended, the web parts for the new network cluster and/or group may become available in a catalog of web parts for the member. It should be noted that the member may comprise a group or an individual user. The member may extend his membership to as many clusters as desired, and associated web parts will become available to the member.

### BRIEF DESCRIPTION OF THE DRAWINGS

FIG. 1 is a diagram of a super cluster according to exemplary embodiments.

FIG. 2a is a block diagram of an exemplary network cluster.

FIG. 2b is a block diagram of an example network cluster.

FIG. 2c is a block diagram of an example of overlapping network clusters.

FIG. 3 is a block diagram of an exemplary hierarchical structure within one group-centric network.

FIG. 4 is a block diagram of an exemplary network host.

FIG. 5 is a block diagram of an exemplary accounts engine of the network host.

FIG. 6 is a block diagram of an exemplary administrative engine of the network host.

FIG. 7 is a block diagram of an exemplary profile.

FIG. 8 is a flowchart of an exemplary method for extending a profile between networked clusters.

### DETAILED DESCRIPTION OF EXEMPLARY EMBODIMENTS

Embodiments of the present invention provide universal profiles for user between clusters of group-centric networks. For simplicity, these group-centric network clusters are herein referred to as network clusters. In various embodiments, each network cluster is a collection of common-interest or topic-specific group-centric networks associated with a particular subject matter. In various embodiments, the group-centric network allows organizations to be represented and made functional over a communication network, such as the Internet. Groups, projects, and services of each organization may then be connected through managerial, functional, and business relationships, established within and according to an organizational structure, as discussed herein. According to some embodiments, the group-centric network may comprise group-centric social networks. In alternative embodiments, the group-centric network may comprise a group-centric enterprise, business, or educational network, or any other type of group or community based network.

In exemplary embodiments, profiles may be extended when new memberships are established between network clusters and/or group-centric networks, as well as groups in these network clusters. As such, a single profile may be utilized across several network clusters and/or group-centric networks.

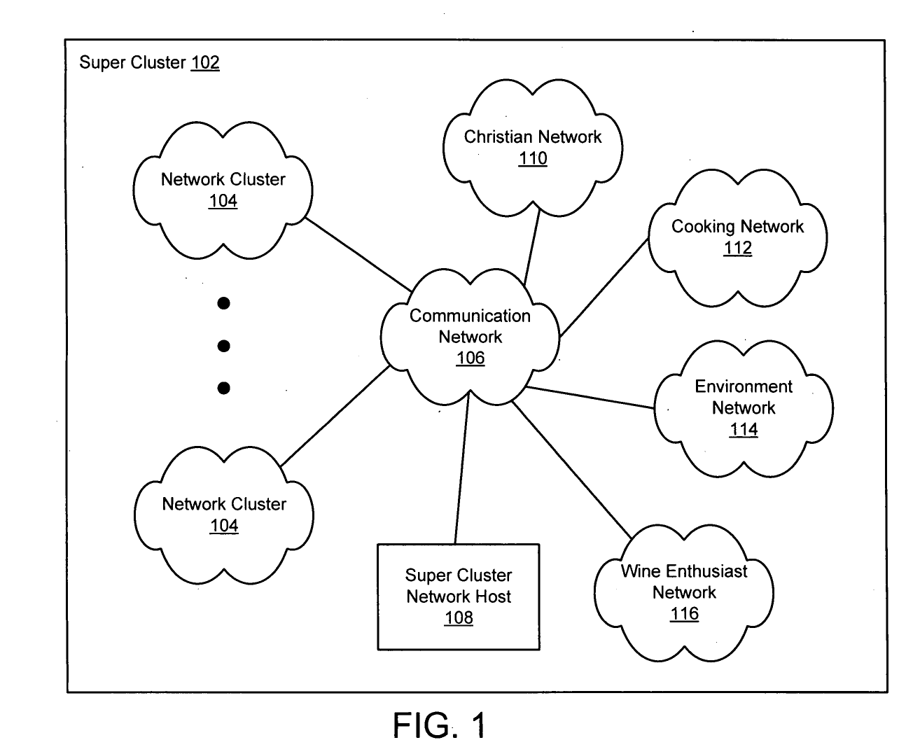

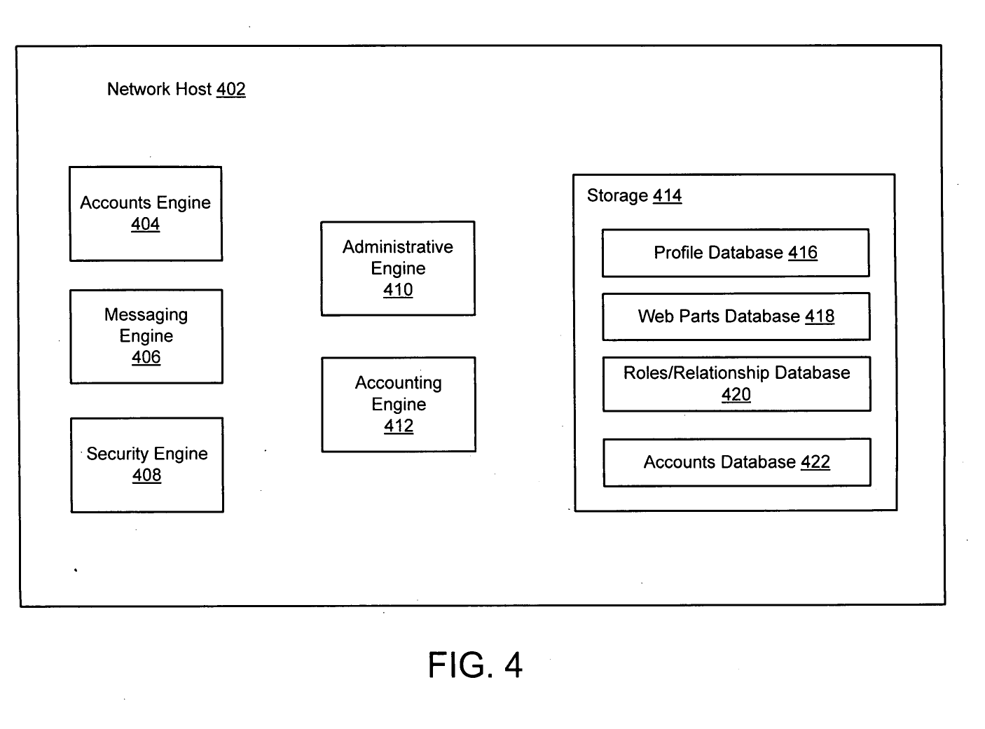

Referring to FIG. 1, a general environment in which embodiments of the present invention may be practiced is shown. In exemplary embodiments, a super cluster 102 comprises a plurality of network clusters 104 coupled in communication in a communication network 106. The super cluster 102 may be administered via a super cluster network host 108, which will be discussed in more detail in connection with FIG. 4 to FIG. 6.

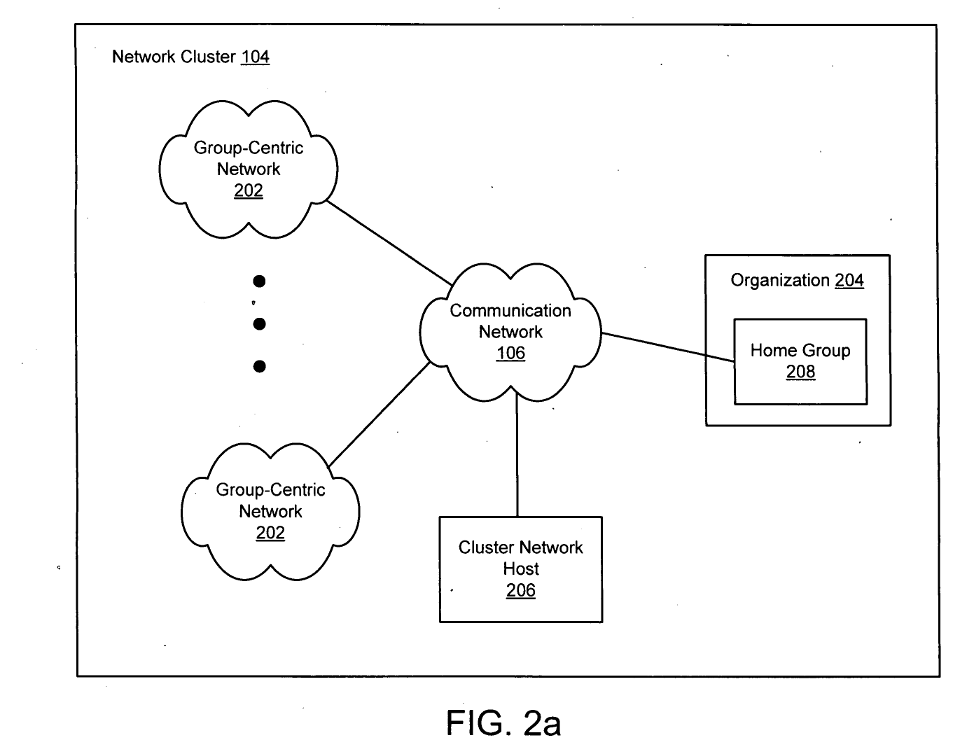

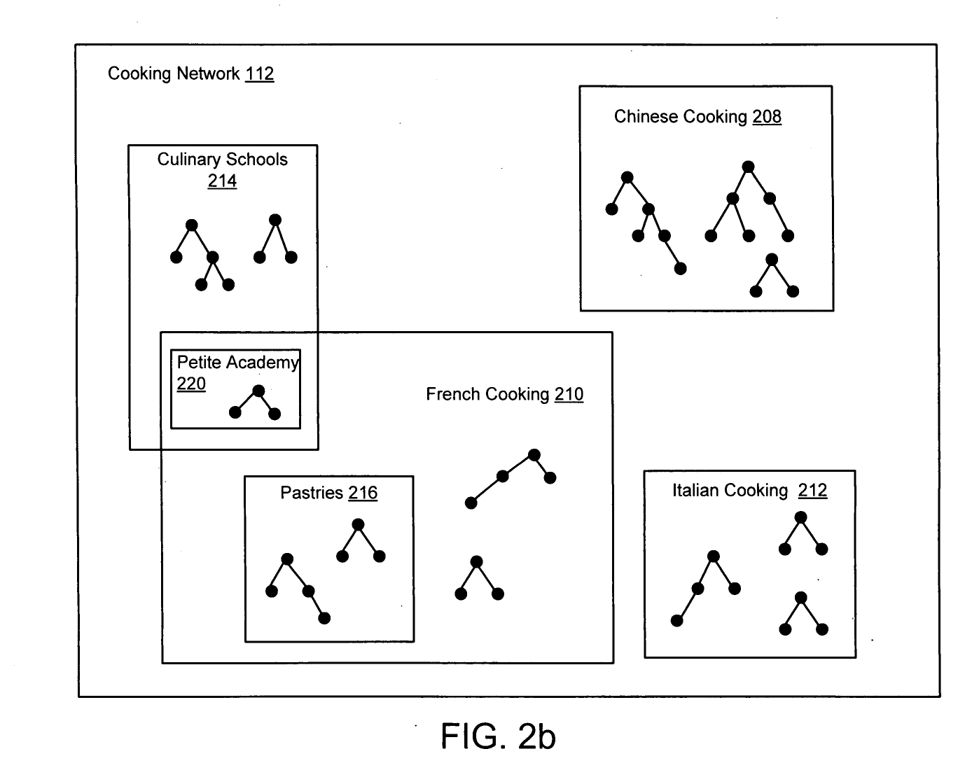

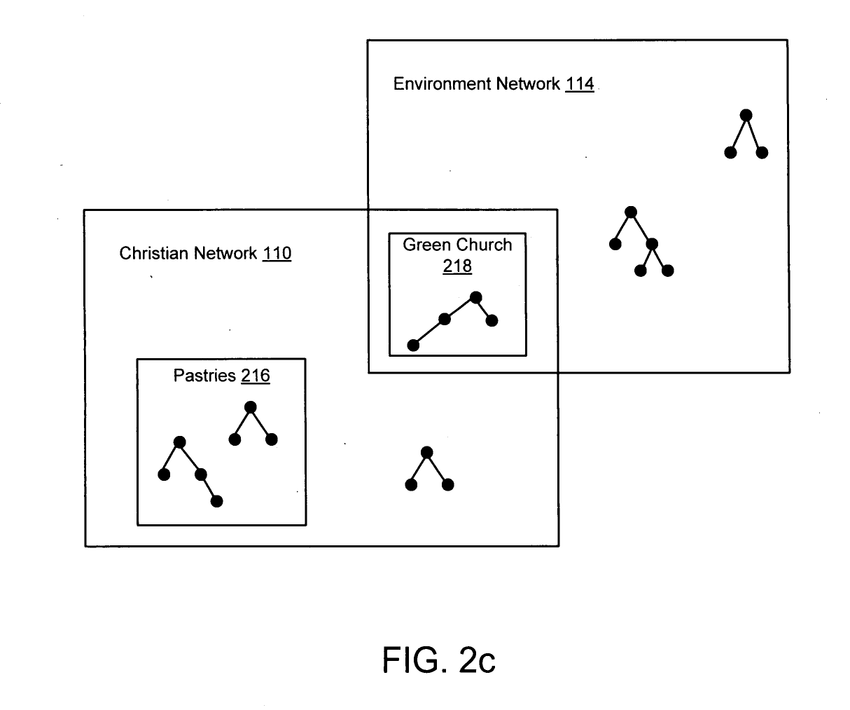

Each network cluster 104 comprises a plurality of related organizations, as will be discussed in more details in connection with FIG. 2a to FIG. 2c. In exemplary embodiments, each network cluster 104 is directed to a particular theme, common goal, or association. For example, the network clusters 104 may represent a Christian network 110, a cooking network 112, an environment network 114, wine enthusiast network 116, or any other collection of organizations or groups having a common interest. As such, the super cluster 102 may be a collection of unrelated network clusters.

It should be noted that FIG. 1 illustrates one exemplary embodiment of the super cluster 102. Alternative embodiments may comprise any number of network clusters 104 coupled to any type of communications network 106. Additionally, more than one super cluster network host 108 may be present.

Referring now to FIG. 2a, the network cluster 104 is shown in more detail. The exemplary network cluster 104 comprises a plurality of group-centric networks 202 coupled via the communication network 106. Each group-centric network 202 may represent an organization 204 or specific group(s) of interest. For example, Green Church may be an organization in the Christian network 110, or fusion cooking may be a specific group in the cooking network 112.

The plurality of group-centric networks 202 and organizations 204 may be administered via a cluster network host 206. In exemplary embodiments, the cluster network host 206 comprises one or more servers configured to create and maintain the network cluster 104 of group-centric networks representing organizations 204 and groups within the organizations 204 using various mechanisms to establish the organizations 204, groups, subgroups, and their relationships. These mechanisms may be utilized by the organizations 204, groups, subgroups, and individuals (e.g., members) to set up their presence within the network cluster 104 and the super cluster 102. In some embodiments, the super cluster network host 108 comprises the cluster network host 206.

The organization 204 represents any entity that desires to establish a presence on the network cluster 104. The organization 204 may comprise profit or nonprofit entities, and may be any type of organization, such as businesses, franchises, sponsors, universities, retail chains, advertisers, partners, city governments and its institutions and citizens, affinity groups, interest groups, or simply groups of people sharing a common interest. The sponsors or partners may be organizations 204 which provide goods or services to other organizations 204 in the network cluster 104.

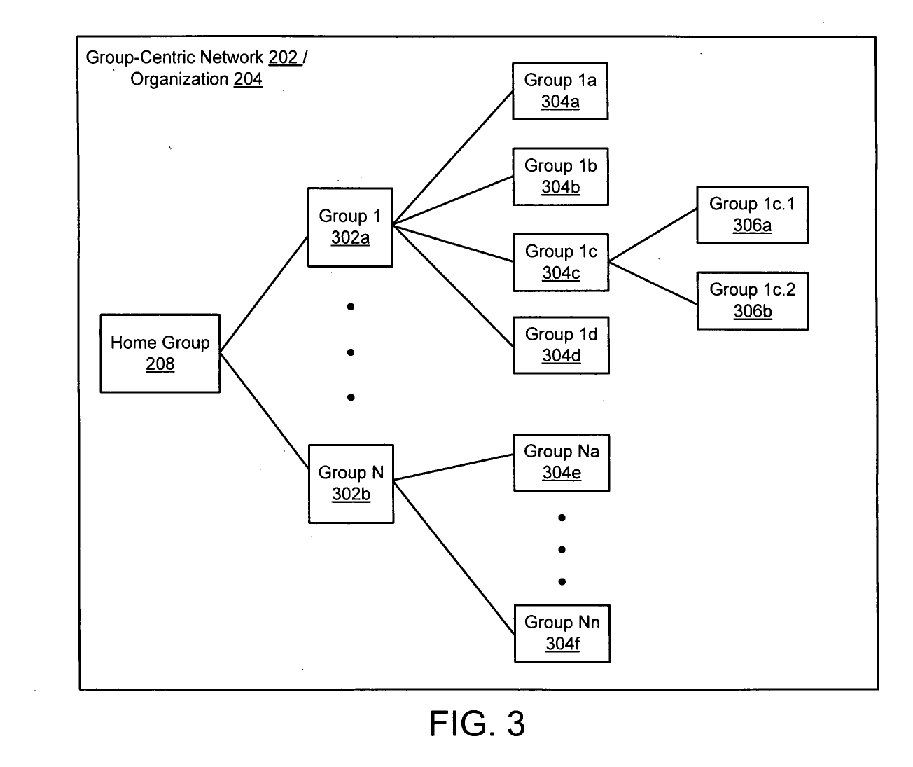

In exemplary embodiments, each organization 204, at a highest level, is represented in the network cluster 104 as a home group 208. The home group 208 is a highest level group in an organization structure that may be established for the organization 204. Each home group 208, in turn, may be linked to one or more subgroups. These subgroups are termed “child groups” of the home group 208 as they are spawns off of the home group 208 or “parent group.” An example of this organizational structure will be discussed in connection with FIG. 3.

It should be noted that FIG. 2a illustrates one exemplary embodiment of the network cluster 104. Alternative embodiments may comprise any number of group-centric networks 202 and organizations 204 coupled to any type of communications network 106. Additionally, more than one cluster network host 206 may be present.

A specific example of a network cluster (i.e., the cooking network 112) is shown in FIG. 2b. The cooking network 112 comprises a plurality of group-centric networks of cooking related organizations or groups. In the present example, the group-centric network includes networks for French cooking 210, Italian cooking 212, culinary schools 214, and Chinese cooking 216. Within each group-centric network 210-216, a plurality of linked groups or subgroups, as will be discussed in more detail in connection with FIG. 3, is present.

In some embodiments, the network cluster 104 may, itself, include one or more secondary network clusters 104 nested within it. For example, the cooking network 112 (i.e., network cluster 104) may comprise a French cooking cluster 210 (i.e., secondary network cluster), which in turn, includes a pastries group-centric network 218. In another example, a car enthusiast network cluster may comprise a sports car secondary network cluster that includes a hot rod group and a Mustang group. Any number of secondary network clusters 104 may be nested within a primary network cluster 104. Furthermore, any number of levels of clustering may be provided. For example, the pastries group-centric network 216 may actually be a pastries network cluster having a croissant group-centric network.

In further embodiments, a group-centric network 202 may exist within two or more network clusters 104. As illustrated in FIG. 2c, Green Church 220 (i.e., a group-centric network 202) is a member of both the Christian network 110 and environment network 114, whereby the Christian network 110 and environment network 114 are both network clusters 104.

Similarly, a group-centric network 202 may be a member of two nested network clusters 104. For example and referring back to FIG. 2b, Petite academy 222 is a group-centric network 202 that is a member of both the French cooking (secondary) cluster 210 and the culinary schools (secondary) cluster 214.

As shown, any level of abstraction may be utilized in organizing network clusters 104, nested network clusters, and group-centric networks 202. Furthermore, overlaps in network clusters 104 and nested network clusters may occur at any level and between any number of such network clusters 104.

Referring now to FIG. 3, an exemplary organizational structure for the organization 204 (e.g., a group-centric network 202) is shown. The overall organization 204 is represented in the network cluster 104 as the home group 208. The home group 208 may comprise (e.g., be linked to) one or more child groups. In FIG. 3, the home group 208 is shown directly coupled to a plurality of child groups (group 1 302a through group N 302b). Any number of these first level child groups 302 may be coupled to the home group 208. For example, if the organization 204, and thus the home group 206, represents Wood River Church on the Christian network 110, then the child group 1 302a may represent Small Groups Ministry of the Wood River Church. The groups 208 and 302-306 are entities that have a level of importance similar to an individual. That is the groups 208 and 302-306 may comprise profiles, profile pages, web pages, role and relationships (e.g., permission rights set for different roles of members), and catalog of web parts (e.g., components used to build web pages).

Furthermore, each first level child group 302 may be coupled to one or more second level child groups. As shown, child group 1 302a comprises a plurality of second level child groups (e.g., group 1a 304a through group 1d 304d). Similarly, child group N 302b is coupled to a plurality of second level child groups (group Na 304e through group Nn 304f). Any number of second level child groups 304 may be established and coupled to the first level child group 302. As a result, the first level child group 302 becomes a parent to the second level child group 304. Alternatively, the first level child group 302 may not be coupled to any second level child groups 304.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small ministry group.

As further shown, the second level child group 304, itself, may be a parent to third level child groups 306. The organizational structure allows any number of levels of child groups to be established within a single organization 204. Additionally, any number of parent-child relationships may be established within the organizational structure represented on the communication network 106 with any specific child group having one parent.

Each group within the organization 204 (e.g., home group 208, child groups 302-306) as well as each user (e.g., individual member) are defined by its profiles, functions (e.g., web parts), and relationships (e.g., friends, members, etc.). The group's profile may be extended to include profile specific pages for that type of group and users connected to (e.g., members of) that group may have their personal profiles extended with user information pertinent to that type of group. The group information may include, for example, characteristics, purpose, specific questions asked, preferences, identification of a group leader, and contact information for the group leader. The user information may comprise contact information, interest areas, specific questions asked, preferences, photos, etc. Depending on the network cluster 104 and the subject matter of the network cluster 104, profile segments and associated catalog of web parts (e.g., for creating the profile and web pages and providing functionality) for each group 208, 302-306 and user may differ between different network clusters 104, as is further discussed herein.

The profiles or web parts may also comprise security settings for the groups 208, 302-306 as well as for each individual user in the network cluster 104. According to one embodiment, the profile or web parts may comprise general security settings for all data associated with the group 208, 302-306 or user. For example, only logged in group members may be allowed to access data on a group's web page. Alternatively, the profile or web parts may set default security settings for each component on a web page created for the group or user. In some embodiments, the components may comprise different security settings such that some data may be accessed only by group members, and other data, for example, may be accessed by the public or friends. It should be noted that similar profiles, profile segments, and web part functionalities as well as security settings may be applied to network clusters 104.

Each organization 204 may be represented in the network cluster 104 as an organizational structure comprising groups 208, 302-306 networked together through various relationships. These relationships establish how each group 208, 302-306 is coupled within the organizational structure to other groups 208, 302-306 and individual users. Exemplary relationships may comprise line relationships, lateral relationships, staff relationships, functional relationships, group membership relationships, and individual membership relationships. The line relationship comprises a direct parent-child relationship between two groups 208, 302-306 in the organizational structure. For example, there is a parent-child relationship between the home group 208 and first level child group 1 302a.

The lateral relationship comprises a relationship between groups on the same hierarchical level. In the example of FIG. 3, there is a lateral relationship between child group 1 302a and child group N 302b.

The staff relationship comprises a relationship between, for example, an administrative group and other groups 208, 302, 304, or 306 for advisory purposes. For instance, an information technology group may form relationships with a plurality of child groups 302-306 in order to provide technical assistance.

The functional relationship may comprise a relationship between a special purpose group and other groups 208, 302, 304, or 306. In some embodiments, this relationship comprises a line relationship that relates to the special function of the group. In one embodiment, the relationship of the special purpose group (e.g., church store) may allow a member of the special purpose group to access and change data on a webpage of another group. For example, a member of the church store may access and edit advertisement for the church store on a group's webpage.

The group membership relationship comprises a relationship that establishes that a group belongs to an organizational structure. This relationship is, in some embodiments, established with the home group 208 of the organization 204. In other embodiments, membership may be between two independent organizations 204 (each one with its own home group 208), wherein one organization 204 is a member of the other organization 204. An example of this comprises a church denomination and its churches. Both are organization 204 having independent group hierarchies with their own home groups 208. However, there is a membership relationship between the home group 208 of each church (e.g., organization 204) of that denomination and an organization 204 of the church denomination hierarchy. A specific example comprises the Orlando Church of the Nazarene, which is a member of the Nazarene Denomination through a relationship of the Orlando Nazarene Church home group with the group “South East Region” of the Nazarene Denomination hierarchy.

The individual membership relationship comprises relationships established between an individual user and the groups 208, 302-306 making that individual a member of that group 208, 302-306. Members comprise individuals that participate in the group 208, 302-306 in different roles. The roles may comprise leaders, project managers, general members, and so forth. The user may also have a role as a “friend” or as “public” (e.g., not logged in or not a direct member of the group in question). These roles may define access and functionality levels granted to the individual.

Furthermore, there may be two types of relationships: within the organization 204 and outside of the organization 204. Within the organization 204, there are relationships between groups 208 and 302-306 (e.g., parent and child) and individual relationships (e.g., member, leaders). Outside of the organization 204, relationships may be established between different organizations 204 (e.g., sponsorship, partnership, etc.). In some embodiments, the establishment of relationships may be based on criteria. For example, if a sponsor is looking to sponsor Baptist churches within a 20 mile radius, then a church (i.e., organization 204) fitting these criteria may establish a relationship with this sponsor.

Once activated, each group 208, 302-306, as well as users, may be represented on the communication network 106 by one or more web pages. These web pages may reflect the group's or user's profile, functions, relationships, leadership, and members. As such, the web pages may be customized by each group 208, 302-306 or user. In exemplary embodiments, the web pages are created using web parts (e.g., programs or components used to build these web pages). Each network cluster 104, group-centric network 202, and groups (e.g., groups 208, 302-306) may comprise different sets of web parts provided to its members (e.g., individual users and groups 208 or 302-306).

It should be noted that all of the relationships described within and between group-centric networks 202 may be applied at the network cluster 104 level. For example, two related network clusters 104 may have a lateral relationship. In another example, one network cluster 104 may be a parent to another network cluster 104 (i.e., nesting of one network cluster 104 in another).

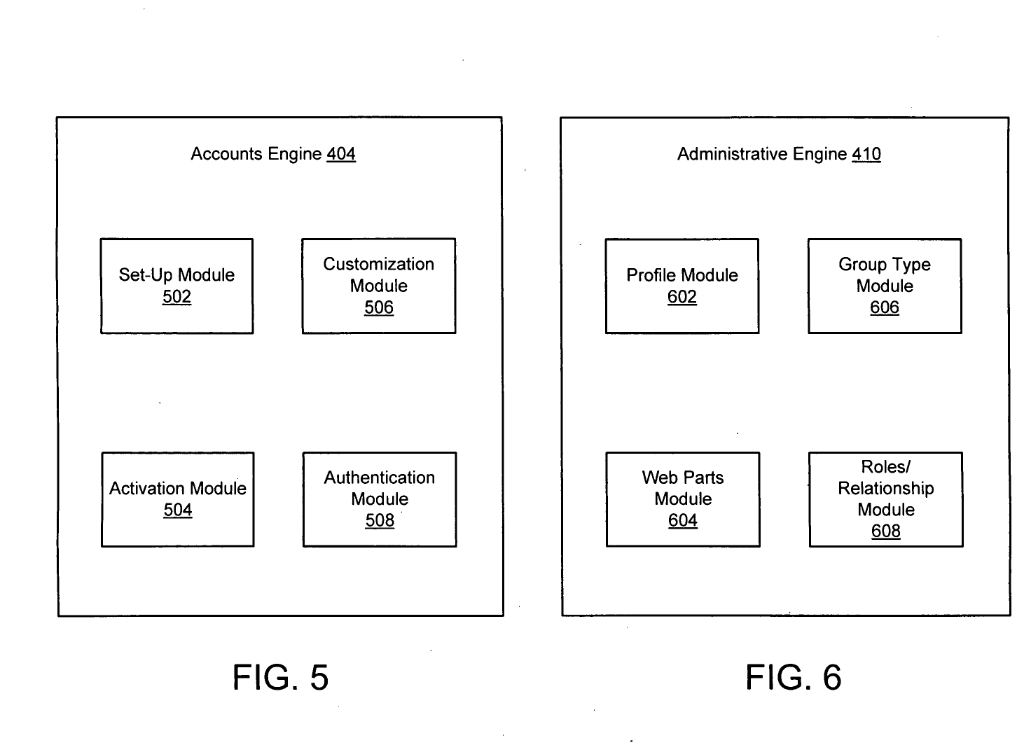

Referring now to FIG. 4, the network host 402 is shown in more detail. The network host 402 may comprise the cluster network host 206, the super cluster network host 108, or a combination of the two network hosts 206 and 108. In further embodiments, components of the network host 402 may be found in both the cluster network host 206 and the super cluster network host 108, whereby the super cluster network host 108 is configured to function at the super cluster 102 and network cluster 104 level and the cluster network host 206 is configured to function at the network cluster 104 and group-centric level. In exemplary embodiments, the network host 402 comprises an accounts engine 404, a messaging engine 406, a security engine 408, an administrative engine 410, an accounting engine 412, and storage 414. The exemplary accounts engine 404 is configured to manage the network clusters 104 within the super cluster 102, and will be discussed in more details in connection with FIG. 5.

The exemplary messaging engine 406 is configured to provide mechanisms to communicate within the communication network 106 including providing handshake mechanisms for creating, administering, and maintaining the cluster networks 110 within the super cluster 104. The messaging engine 406 will, in exemplary embodiments, generate and forward messages (e.g., e-mails, notes) to, and between, individuals (e.g., group leaders, administrative staff, users, etc.) of the network clusters 110. For example, messages may be utilized to establish a new network cluster 110 in the super cluster 104.

In exemplary embodiments, the security engine 408 limits access and functions within the super cluster 102 and network clusters 104. For example, an administrator of a network cluster 104 may have be allowed to change the network cluster 104 profile segments and data elements and web part catalog. However, a general user of the super cluster 102 or member of a network cluster 104 will only be allowed to enter data in his instance of the profile extensions, which may be appended to his original profile.

The exemplary administrative engine 410 works with the accounts engine 404 to establish a network cluster 104 in the super cluster 102. Specifically, the administrative engine 410 allows an administrator to define administrative components (e.g., profile segments, web parts, roles) for the network cluster 104 and all groups 208 and 302-306 within the network cluster 104. In some embodiments, the administrative engine 410 may be a part of the accounts engine 404. The administrative engine 410 will be discussed in more details in connection with FIG. 6.

The exemplary accounting engine 412 is configured to maintain accounting and billing information for each network cluster 104 as well as each group-centric network 202. In various embodiments, each group-centric network 202 subscribes to a particular level of service with the network host 402. The level of service may determine a certain number of megabytes of storage and bandwidth on the communication network 106 and types of features (e.g., customized catalog of web parts) available to the group-centric network 202, for example.

The storage 414 is configured to store various databases associated with the network clusters 104 and group-centric networks 202. In exemplary embodiments, the storage 414 comprises a profile database 416, web parts database 418, roles/relationship database 420, and accounts database 422. These databases 416-422 are exemplary and alternative embodiments may comprise more or less databases or combine some of the databases 416-422 together. For example, other databases may provide layouts and themes, or store events, news, and blogs for the network clusters 104 and group-centric network 202.

The exemplary profile database 416 may store profile information for each group-centric network 202, organization 204, group 208 and 302-306, and individual (e.g., individual users who are members of the network cluster 104 or one of the group-centric networks 202 in the network cluster 104) within the network cluster 104. The profile database 416 may also store profile information for the network cluster 104 and super cluster 102. Profile information may comprise name, contact information, security settings, preferences, attributes, history, and so forth. For each group-centric network 202, a general profile may be established. In some embodiments, the general profile will comprise default settings including default security settings that will apply to various web part components or data provided by the group-centric network 202. In some embodiments, the profile database 416 may also comprise profile segments associated with the network cluster 104 and/or group-centric networks 202, as will be discussed in more detail below.

In exemplary embodiments, the web parts database 418 comprises components that are provided to customize a web page of network clusters 104, group-centric networks 202, groups (e.g., group 302-306), and individual members. Icons representing these web parts may be shown, for example, on a pop-up window or on a side of the web page during web page customization. An administrator for the network cluster 104 may define cluster specific web parts to a catalog of available web parts for the network cluster 104 or group-centric network 202. Furthermore, an administrator for a group-centric network 202 or groups within the group-centric network 202 may drag and drop an appropriate icon onto a location of the web page where the selected component should appear in order to customize the group-centric network 202 or group web page. If a user connects to a group 208 or 302-306 on that network cluster 104, his catalog of available web parts will be augmented with the web parts defined by the cluster administrator. The user now may drag and drop an appropriate icon onto a location of the web page where the selected component should appear in order to customize his personal web page. In various embodiments, the web parts components also enable functions on the web pages. In some embodiments, the super cluster web parts available to the network clusters 104 and super cluster users may be generic since the super cluster, itself, is not topic specific. In other embodiments, customized catalogs of web parts that are available to each network cluster 104 and groups,208 and 302-306 may be provided from the web parts database 418. In exemplary embodiments, customized catalogs of web parts that are available to each group and members of the group may be provided from the web parts database 418.

Each web part component may also allow the individual to select or set a security setting for access to data for that web part. As such, web part security is based on roles and relationships which determine functionality and access rights available to a user accessing the web part on the group or user web page. For example, a group-centric network web page may have an events web part. The events web part may be configured to be viewed by anyone (e.g., guests, members), but only members of the group-centric network 202 are allowed to register for events. These security settings may not be profile based but are specified by editing the web part settings.

The roles/relationship database 420 may, in some embodiments, store an individual's roles (e.g., responsibilities and permissions within groups) with respect to the network cluster 104 and/or the group-centric network 202. These roles may, in one embodiment, be based on relationships between individuals and the home group 208 and/or child groups 302-306 as well as the network cluster 104. These roles may, for example, identify an individual as a leader of the home group 208 (e.g., power over functions performed within the home group 208 and the organization 204 and has access to all information handled by the home group 208), officer or member (e.g., has limited powers to perform functions and access information as defined by the group manager), administrator (e.g., responsible for technical and administrative maintenance of the organization 204), friend (e.g., not a member by a known individual associated with the user), or guest (e.g., public which may be registered or unregistered with the network cluster 104 or group-centric network 202). As a result, the role of the individual determines access to data and functionalities enabled for the individual within the network cluster 104 and the group-centric network 202.

The exemplary roles/relationship database 220 may also comprise tables storing relationships between the various network clusters 104, group-centric networks 202, groups 208 and 302-306, and individuals within the super cluster 102. Such relationships may include, but are not limited to, parent-child relationships, sponsor-organization relationships, partner-organization relationships, members-group relationships, advertise-organization relationships.

The exemplary accounts database 422 is configured to store account information for network clusters 104 and super cluster users. The account information may include the defined administrative components as will be discussed in FIG. 6.

FIG. 4 has been discussed in relations to the cluster network host 206. However, some of the engines and databases of FIG. 4 may be embodied within the super cluster network host 108. It should also be noted that the embodiment of FIG. 4 is exemplary and that alternative embodiments may comprise more, less, or other functionally equivalent components.

Referring now to FIG. 5, the exemplary accounts engine 404 is shown. The accounts engine 404 is configured to create and maintain group-centric networks 202 and groups within the group-centric network 202 (e.g., home group 208 and groups 302-306), as well as individual user accounts. In exemplary embodiments, the accounts engine 404 comprises a set-up module 502, activation module 504, customization module 506, and authentication module 508.

The exemplary set-up module 502 is configured to receive account information for account set-up. In exemplary embodiments, the account is for a group-centric network 202, group 208 or 302-306 within the group-centric network, or individual user. In one embodiment, the account information may be received via a graphical user interface. The graphical user interface may provide a plurality of fields where an individual establishing the account enters information such as, for example, contact information, profile and relationship information, billing and service plan information, and so forth.

In accordance with some embodiments, an account may be created based on a request, but the account may be inactive until activated by the activation module 504. With respect to a request to create a new group-centric network 202, group 208 and 302-306, the request (e.g., account information) may be filtered through a plurality of criteria to determine if the request is approved. The filtering may be performed manually or automatically (e.g., by the set-up module 502 or activation module 504). If all criteria are met, the account may be activated.

With respect to activation of a group centric network 202 or groups 208 and 302-306, the activation may also be based on an approval process utilizing handshake mechanisms. For example, if a new group-centric network 202 wants to be established within the network cluster 104, a handshake process (e.g., a “belong” request or handshake) may be performed for approval and activation of the new group-centric network 202.

Approval and activation within the network cluster 104 may also include approving membership for an established group-centric network 202 within a new network cluster 104. In a further example and referring back to FIG. 3c, if the Green Church 220 is established within the Christian network 110, but wants to extend to be a part of the environment network 114, a request (e.g., “join” request or handshake) to the environment network host may be necessary. In this embodiment, the activation module 504 is configured to perform the approval process. In one embodiment, the activation module 504 may trigger the messaging engine 406 to performing a message-based handshake between the Green Church 220 and the environment network host. Assuming, the environment network host approves, the Green Church (e.g., administrator) will be notified and appropriate extensions (e.g., profile segments, web parts, group types, roles) are provided to the Green Church and its members.

While examples have been provided for extending membership for a group-centric network, embodiments of the present invention may allow individual members to extend their membership. In various embodiments, the individual may join a group 302-306 within a group-centric network 202, a group-centric network 202, or network cluster 104. Extending membership may include providing account information or sending a request (e.g., a message-based handshake mechanism) in accordance with some embodiments. Once membership is extended, the member has access to profile segments and web parts specific to the new group or network cluster 104 just joined.

The exemplary customization module 506 is configured to allow the customization of the group-centric network 202, group 208 and 302-306, or individual use's profile and web page (i.e., profile page). In exemplary embodiments, the customization module 506 provides the profile segments and catalog of web parts to a user for customizing their profile and web page. When membership is extended to a new group 208 and 302-306 or network cluster 104, the customization module 506 may provide the profile extensions (e.g., new profile segments for the new group or network cluster 104) and append the catalog of web parts available to the user to extend their profile page. Super cluster web parts may be generic web parts, while network cluster and group web parts are customized (i.e., defined) for the network cluster 104 and groups.

The exemplary authentication module 508 authenticates individuals accessing the network cluster 104 and group-centric networks 202. In some embodiments, the authentication module 508 will verify a user identifier and password for an individual access the network cluster 104 and group-centric networks 202 by comparing the user identifier and password with one stored in the profile database 414. Once authenticated, the individual may access data or perform actions based on their roles and relationships (e.g., as determined based on data in the roles/relationship database 418) within the network cluster 104 and/or the super cluster 102.

Referring now to FIG. 6, the exemplary administrative engine 410 is shown. When a group-centric network 202 and/or the network cluster 104 is established, components within the group-centric network 202 and/or network cluster 104 may be defined (e.g., the subject matter and content of the group-centric network 202). Defining the group-centric network 202 and/or network cluster 104 comprises defining various administrative components that may be necessary or utilized within the group-centric network 202 and/or network cluster 104. The administrative engine 410 is configured to establish these customized administrative components. These administrative components may include profile segments, web parts, group types, and roles/relationships for groups (e.g., groups 302-306) within the group-centric network 202. As such, each group 302-306, group-centric network 202, and network cluster 104 may have customized administrative components available to their members. The exemplary administrative engine 410 may comprise a profile module 602, web parts module 604, group type module 606, and roles/relationship module 608. It should be noted that in some embodiments the functionalities of the administrative engine 410 may be associated with the accounts engine 404.

Additionally, the functionalities of the administrative engine 410 may be divided between the super cluster network host 108 and the network cluster host 206. For example, administrative components for the network cluster 104 and the group-centric network 202 may be defined at the super cluster network host 108 (e.g., administrative engine of the super cluster network host 108), but administrative components for individual groups (e.g., groups 302-306) within the group-centric network 202 may be defined with the administrative engine 408 of the cluster network host 206.

The profile module 602 is configured to define the profile segments for the groups 208 and 302-306, the group-centric network 202, and the cluster network 104. For example, the administrator of the cluster network 202 may define and establish the profile segments for their groups (e.g., groups 302-306). A profile segment comprises a profile entry or data elements that are directed to a profile of a member and which may be unique to a particular group 208 and 302-306, group-centric network 202, or network cluster 104. For example, a missionary group within the Green Church may have a profile segment “My Missions.” These profile segments may be utilized by the missionary group to hold profile information specific to their missions group.

Profiles may vary depending on a user type or group type. For example, a church organization may have different profiles for a house church type group and a youth group. Each individual may have a different profile based on age, user type, and/or if the individual belongs to more than one user type. For example, an individual who is a missionary may have additional profile segments or profile data elements if the individual is also a filmmaker. In this case, the profile may be extended to encompass additional profile data elements particular to a filmmaker. The profile extension also applies to groups. For example, a group called “Youth with a Mission” may fit the profile of both a youth group and a missionary group. The group profile for this group may include data elements for both group type profiles. Additionally, profiles may be extended based on surveys responded to by users, individuals, and groups. The profiles may be utilized to establish associated profile pages (i.e., web pages) unique to each group or individual.

The profiles may also comprise security settings for members of the group 208 and 302-306 as well as for members of the network cluster 104 (in which the group-centric network 202 exists), and super clusters users. According to one embodiment, the profile may comprise general security settings for all data associated with the profile. For example, only logged in group members may be allowed to access data on a group's web page. Alternatively, the profile may set default security settings for each component on a web page. In this embodiment, the components may comprise different security settings such that some may be accessed only by group members, specific individual(s), network cluster(s) 104, super cluster(s) 102, specific roles and/or relationships, or a combination thereof, and other data, for example, may be accessed by the public.

The web parts module 604 is configured to define the web parts for the groups 208 and 302-306 of the group-centric network 202 and the network cluster 104. Web parts comprise components or programs used to build profile pages (i.e., web pages). Continuing with the previous examples, the missionary group may have a “Cause Offering” web part component, while a youth ministry sub-group of the missionary group may have a “My Adventures in Service” web part. The network cluster administrator may define and establish via the web parts module 604, the web parts that will be made available for an administrator of a group centric network or member to use on their group-centric network 202. These web parts may then be available to the group centric network administrator, group administrator, or members via their respective catalog of web parts for customizing their web pages. In some embodiments, web parts may be further refined and/or established by a group-centric network 202 administrator for groups (e.g., groups 302-306) within their group-centric network 202.

The exemplary group type module 606 establishes various group types for the network cluster 104 and sub-group types for the group-centric network 202. These sub-group types may define the types of sub-groups that are established within the group-centric network 202. For example, a “mission ministry” sub-group type may be defined for the “church” group type. In exemplary embodiments, an administrator for the network cluster 104 may define the group types allowed for the network cluster 104. When a group is created within the network cluster 104, a group administrator may define which of the available group types will be assigned to that specific group. In some embodiments, the group administrator may also define sub-group types. Alternatively, sub-group types may be defined by the network cluster administrator.

The roles/relationship module 608 is configured to define roles and relationships for the network cluster 104 including the group-centric networks 202. Each network cluster 104 and group-centric network 202 will have customized roles and relationships which may determine access and functionality within the network cluster 104. Thus, for example, when an organization 204 (e.g., group-centric network 202) or group 208 and 302-306 is established within a network cluster 104, an administrator of that organization 204 or group 208 and 302-306 defines entitlements for a user to data and functions within the organization 204 in terms of a user's role or relationship with the organization 204. Via the roles/relationship module 608, the administrator may define different functional behavior and data visibility (e.g., data access) for each different relationship that a user may have with the organization 204. Even if the user does not have a relationship (e.g., guest or public) with the organization 204, different functional behavior and data visibility may be defined based on the user's role and relationship with the network cluster 104 or super cluster 102. This allows for different functional behavior and data visibility to anonymous users, super cluster members, network cluster members, and group-centric network members.

For example, an administrator for the French cooking group 210 in the cooking network (cluster) 110 can define that a user accessing the French cooking group 210 may see recipes if he is a member of the cooking network 110 even if the user is not a member of the French cooking group 210. Because the user is a member of the cooking network 110, the user is given access rights to the recipes. Continuing with this example, an anonymous user or a super cluster member who is not a member of the cooking network 110 will not be able to see the recipe. Furthermore, the administrator for the French cooking group 210 may define that only users who are both members of the French cooking group 210 and have a role of a chef within the French cooking group 210 are allowed to post recipes with the French cooking group 210 (i.e., role=chef; relationship=within the French cooking group 210). Any combination and any number of combinations of roles/relationships may be defined for each organization 204 and/or groups 302-306.

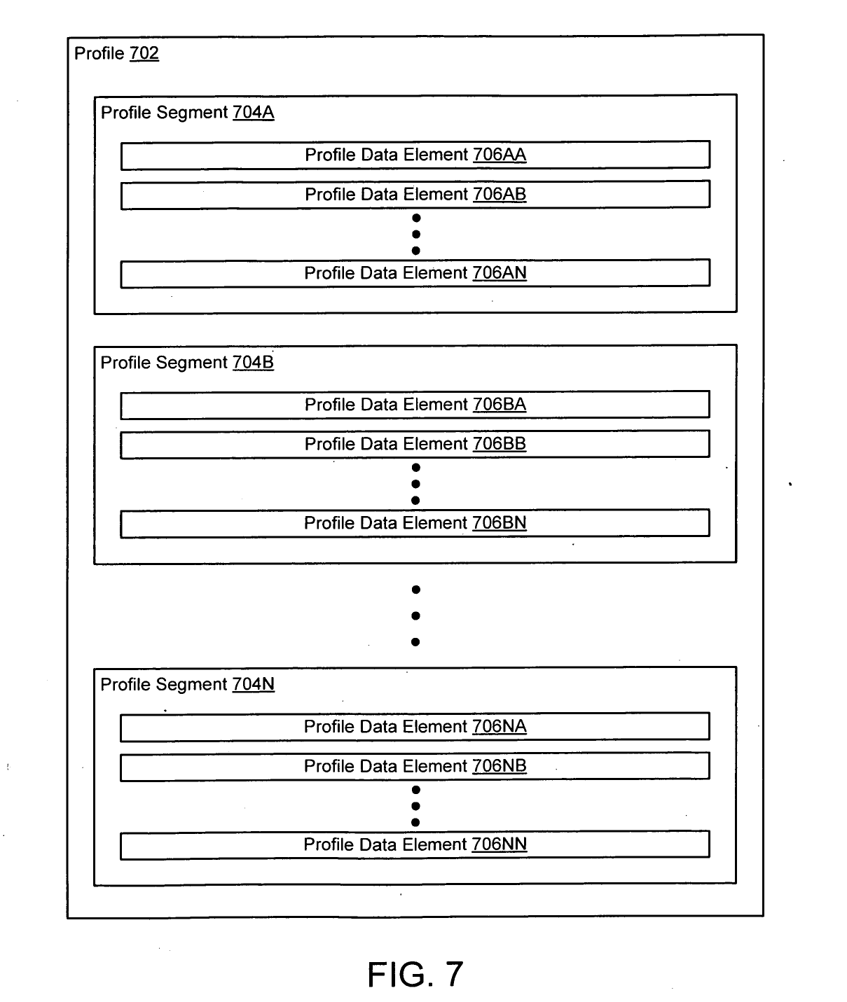

Turning to FIG. 7, a block diagram of an exemplary profile 702 is shown. The profile 702 may be established for a network cluster 104, group-centric network 202 (e.g., organization 204), group-centric network 202, groups 208 and 302-306, and individual users. The profile 702 may comprise one or more profile segments (e.g., profile segment 704A, 704B, and 704N). In turn, each profile segment may comprise profile data elements (e.g., profile data elements 706AA-706AN, 706BA-706BN, and 706CA-706CN). In one example, the profile data elements 706 comprise answers to questions posed to an individual user. It is noted that the profile segments and/or profile data elements may be utilized, for example, by the customization module 506 to customize a web page of the group-centric network 202, group 208 and 302-306, or individual user.

According to various embodiments, the profile 702 may be altered by adding or subtracting profile segments 704. This alteration may comprise extending the profile (i.e., providing profile extensions). In exemplary embodiment, profiles may be extended when an entity (i.e., group-centric network 202, group 208 and 302-306, or user) extends their membership. For example, if a user of the super cluster 102, who is not a member of a specific network cluster (e.g., network cluster 104), connects with (i.e., joins) a particular group-centric network (e.g., group-centric network 202) within the specific network cluster, then membership of the super cluster user will be extended to both the particular group-centric network and the specific network cluster. Accordingly, the profile 702 of the user may be appended with profile segments corresponding to both the particular group-centric network 202 and the specific network cluster 104.

To illustrate, assume the user is not a member of the cooking network (cluster) 112. If the user establishes membership with the group-centric network 202 for Italian cooking 212, the user's membership extends to both the group-centric network 202 for Italian cooking 212 and the cooking network (cluster) 112. Furthermore, the user's profile may be extended as well. The profile extension, in this case, may comprise profile segments associated with the group-centric network 202 for Italian cooking 212 and the cooking network (cluster) 112. In addition, the extended membership may allow the user to have additional web parts available from the web parts database 414. These additional web parts are specific to the newly joined group-centric network 202 for Italian cooking 212 and food network (cluster) 112.

The extension of a given user's profile may also impact the functionality of web sites from the viewpoint of that given user. In exemplary embodiments, as a member of a certain group-centric network 202, and thus a member of the corresponding network cluster 104, the given user may be entitled to view data and/or perform functions on other group-centric networks within the same network cluster 104. For instance, assume that the group-centric network 202 for Italian cooking 212 and French cooking 210 allow their recipes to be viewed by anyone who is a member of the cooking network 110, regardless if they are members of those group-centric networks 212 and 210. However, the recipes may only be posted by members of these group-centric networks 212 and 210. In some embodiments, this ability may be further limited to those that are members of the group-centric networks and have a specific role assigned to them, such as “Chef.”

In cases where a single group-centric network 202 belongs simultaneously to multiple network clusters 104, a user's profile may be extended to all of the multiple network clusters 104, in addition to the single group-centric network 202, when the user joins the single group-centric network 202, in accordance with various embodiments. To illustrate, the user may join the Green Church (group-centric network) 218, which belongs to both the Christian network 110 and the environmental network 114, as shown in FIG. 3c. As a result, the user's membership will be extended to both the Christian network 110 and the environmental network 114. Additionally, the user's profile may be appended to include profile segments 704 that are associated with the Christian network 110 and the environmental network 114. As a result, the user may have a profile which includes a “faith” segment and a “green living” segment, for example.

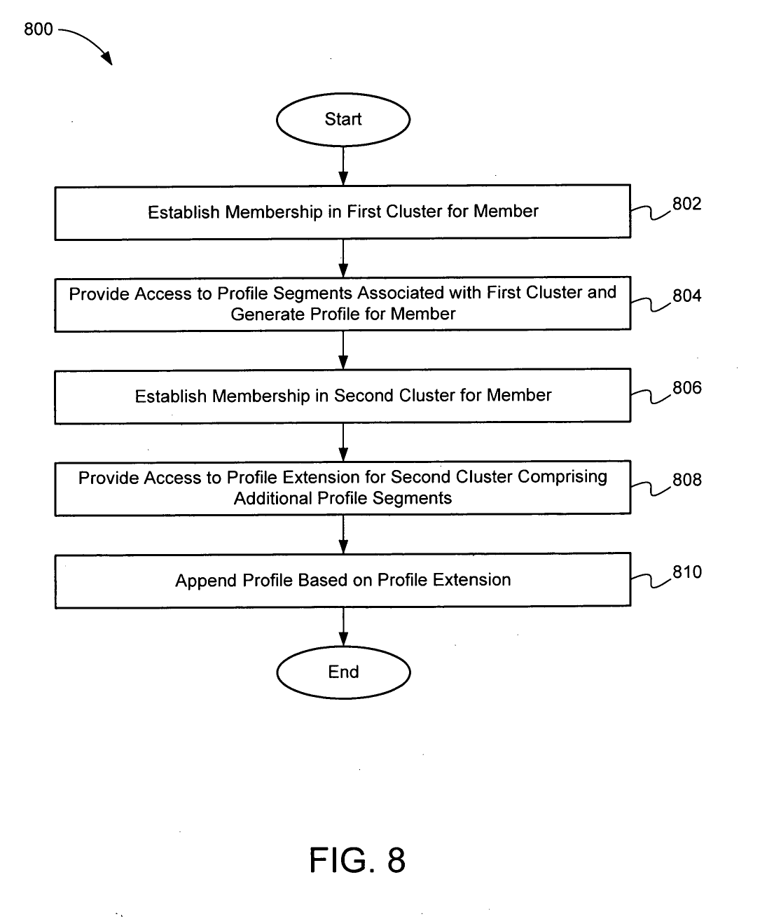

FIG. 8 is a flowchart 800 of an exemplary method for extending a profile between network clusters 104. In step 802, membership in a first network cluster 104 is established for a member. In various embodiments, the member may comprise a group (e.g., groups 208 and 302-306) or an individual. The set up module 502 may be configured to establish membership in the first cluster in exemplary embodiments.

In step 804, the profile for the member is generated. As mentioned in connection with FIG. 7, the profile may comprise profile segments associated with the first cluster. The profile module 602 may be configured to define the profile segments 702 according to exemplary embodiments. Subsequently, the customization module 506 may provide access to the profile segments 702 stored in the profile database 416. These profile segments 702 may then be used to generate the profile.

In step 806, membership in a second cluster is established for the member. As with the first cluster, the set up module 502 may also be configured to establish membership in the second cluster. Membership may be established using message-based handshakes, via meeting present criteria, or any other method.

In step 808, a profile extension is made available for the second cluster. The profile extension may comprise additional profile segments associated with the second cluster. In some embodiments, access to profile extension may be provided by the customization module 506 once the new membership is established. In exemplary embodiments, the member may then choose whether to incorporate the new profile segment into their profile.

In step 810, the profile may be appended based on the profile extension. As discussed in connection with FIG. 7, the profile may be appended by adding additional profile segments. In exemplary embodiments, the customization module 506 may be configured to append the profile in accordance with exemplary embodiments.

Embodiments of the present invention provide security systems and methods for a group-centric social network. In exemplary embodiments, security is based on roles and relationships of the user and groups in the network. As such, a user's association with one or more groups is identified and used to determine a level of access to data and enabled functionalities.

It should be noted that a catalog of web parts available to the member may be extended in a similar manner as the profile extensions. That is, when an entity establishes a new membership, web parts associated with the new membership may be made available in a catalog of web parts for the entity. In exemplary embodiments, the customization module 506 will append the catalog of web parts for the entity with the new web parts available resulting from the new membership. The entity may then choose one or more web parts to, for example, drag and drop onto their web page in order to customize their web page.

For example, a super cluster user, who extends his membership to a group centric network 202 and/or to a network cluster 104, may add new web parts made available by the new group centric network 202 and/or to a network cluster 104 to his personal web page. In doing so, the user will be able to define entitlements necessary for someone to view his web parts by setting its visibility to one or more of the following examples: anonymous user, super cluster member, all friends, set of friends, member of a network cluster 104, or set of network clusters 104, or member of a group centric network 202, set of group centric networks 202, or only by himself (e.g., by making the web part private). As an example lets assume the super cluster user extended his membership to the Green Church (group centric network 202) 218 and adds to his web page a “Video Sermons” web part. He then sets visibility entitlements of the Video Sermon web part to include anyone connected to the Christian network 110 plus his friends A and B. In this case, any other super cluster user who is a member of Christian network 110 will be able to view the new Video Sermons web part on the user's page despite having or not having a connection with that particular user. Friends A and B will also be able to see the Video Sermons web part. Anyone else accessing the web page will not see that web part, according to the entitlements defined by the user.

In terms of notifications, the above super cluster user may have notifications sent to all his friends who were either explicitly listed in the visibility entitlements list or meet one of the other entitlement criteria by belonging to one of the network clusters 104 or group centric networks 202 listed in the visibility entitlements. Notifications may go to all friends if the visibility entitlement included super cluster members. Notifications may be sent according to the profile preferences of each individual friend, which may include, but not be limited to, email notification, SMS text message, and a “New Activity” web part. As an example, let's assume the super cluster user extended his membership to the Green Church 220 and added to his page a “Video Sermons” web part. He them set the visibility entitlements of the Video Sermon web part to include anyone connected to the Christian network 110 plus his friends A and B. Lets also assume that only friend C is a member of the Christian network 110. In this case, notifications will be sent to friends A, B, and C at the time the Video Sermon web part is added to the user's web page and anytime that web part gets updated with a posting of a new video sermon by the Green Church 220. Users A, B, and C have the ability to override the notification setting in their notifications management page in the event they no longer desire to receive such notifications.

It should be noted that the embodiment of FIG. 8 is exemplary. Alternative embodiments may comprise more, less, or other steps. Additionally, any number of further memberships may be established to additional clusters. Furthermore, similar functionalities may occur when a member extends membership between groups within the same cluster.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for extending a profile between network clusters, the method comprising:
establishing membership in a first cluster for a member;
providing access to profile segments associated with the first cluster, the profile segments used to generate the profile for the member;
establishing membership in a second cluster for the member;
providing access to profile extension for the second cluster, the profile extension comprising additional profile segments associated with the second cluster; and
appending the profile based on selected additional profile segments from the profile extension.

2. The method of claim 1, wherein establishing membership in the first cluster further comprises providing a catalog of web parts associated with the first cluster.

3. The method of claim 1, wherein establishing membership in the second cluster further comprises providing a catalog of web parts associated with the second cluster.

4. The method of claim 1 further comprising generating a web page based on selected web parts from a catalog of available web parts based on the memberships.

5. The method of claim 4 further comprising designating entitlements for the selected web parts.

6. The method of claim 5, wherein the selected web parts are viewable by a second member based on the entitlements.

7. The method of claim 5, wherein functions associated with the selected web parts can be performed by a second member based on the entitlements.

8. The method of claim 5 further comprising providing notifications based on the entitlements.

9. The method of claim 1, wherein the member is a group.

10. The method of claim 1, wherein the member is an individual.

11. The method of claim 1 further comprising defining the profile segments.

12. The method of claim 1 further comprising defining web parts available for each work cluster.

13. A system for extending a profile between networked clusters, the system comprising:
an activation module configured to establish membership in a first cluster and second cluster for a member; and
a customization module configured to provide access to profile segments associated with the first cluster and profile extensions associated with the second cluster, whereby the profile extension comprises additional profile segments associated with the second cluster, the profile segments and profile extensions used to generate the profile for the member.

14. The system of claim 12 further comprising a profile module configured to define the profile segments.

15. The system of claim 12 further comprising a web parts module configured to define web parts available in a catalog of web parts for the first cluster and second clusters.

16. The system of claim 12, wherein the page customization module is further configured to provide access to a catalog of web parts available to the member based on the memberships.

17. The system of claim 12 further comprising a roles/relationship module configured to define roles and relationships for the first and second clusters.

18. The system of claim 12 further comprising a set-up module configured to receiving account information for membership.

19. The system of claim 12 further comprising a messaging engine configured to send and receive notifications based on established entitlements.

20. A computer readable medium having embodied thereon a program, the program being executable by a processor for performing a method for extending a profile between network clusters, the method comprising:
establishing membership in a first cluster for a member;
providing access to profile segments associated with the first cluster, the profile segments used to generate the profile for the member;
establishing membership in a second cluster for the member;
providing access to a profile extension for the second cluster, the profile extension comprising additional profile segments associated with the second cluster; and
appending the profile based on selected additional profile segments from the profile extension.
